(19) United States
(12) Patent Application Publication
(10) Pub. No.: US 2008/0189302 A1
(43) Pub. Date: Aug. 7, 2008

(54) GENERATING DATABASE REPRESENTATION OF MARKUP-LANGUAGE DOCUMENT

(75) Inventor: Sai Surya Kiran Evani, Bangalore (IN)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 11/672,115

(22) Filed: Feb. 7, 2007

(51) Int. Cl. G06F 17/30

(52) U.S. Cl. 707/100; 707/E17.005

(57) ABSTRACT

A database representation of a markup-language document is generated. Such a document formed in a markup language, such as the eXtensible Markup Language (XML) and that has a number of nodes organized in a tree structure is parsed. For each node of the document, at least the following is performed. First, a unique numerical identifier for the node is stored in a row of a first database table that represents a structure of the document. Second, a text value of the node is stored in a row of a second database table by the unique numerical identifier for the node. The second database table stores the text values of the nodes of the document. The document is thus accessible by performing query operations against the first database table and the second database table.

### FIELD OF THE INVENTION

The present invention relates generally to documents formatted in markup languages, such as the eXtensible Markup Language (XML), and more particularly to generating database representations of such documents.

### BACKGROUND OF THE INVENTION

Formatting data in markup languages has become a popular way to format data. One common markup language is the eXtensible Markup Language (XML), described in detail at the Internet web site http://www.w3.org/XML/. Markup languages such as XML are a way by which what data “is” can be described, by using a series of tags. As one simplistic example, the XML data “<user name>John Roberts</user name>” specifies that the data “John Roberts” is a user name. A markup-language document can be considered as representing data organized in a tree structure, where each node of the tree holds data.

To process a markup-language document, such as via a Document Object Model (DOM) application programming interface (API), typically the entire document has to be loaded into memory and parsed. Once loaded into memory and parsed, the document can then be accessed, to determine the data stored in the document. However, markup-language documents—that is, documents formatted in a markup language—can become quite large. As a result, processing a markup-language document can result in out-of-memory errors, when available memory is exceeded.

One solution to this problem is known as “lazy loading” of a markup-language document. In lazy loading, a markup-language document, such as an XML document, is loaded into memory from its beginning until the desired data has been loaded into memory. Unwanted elements of the document are thus typically loaded into memory as well, where these elements are those that occur within the document prior to the desired data. Therefore, out-of-memory errors can still occur with lazy loading, when, for example, the desired data is located towards the end of the document in question, and loading the document up to the point of the desired data exceeds available memory.

The lazy loading approach can be improved to decrease the potential for out-of-memory errors to occur by discarding elements from memory that have not been accessed. If the discarded elements are later needed, they are reloaded into memory. However, the tree structure of a markup-language document is always stored in memory, so that the overall organization of the document remains known. Elements are thus discarded from memory in that the data stored in the nodes corresponding to these elements is discarded. Therefore, for very large markup-language documents, out-of-memory errors can still occur, because the tree structure representing the organization of a markup-language document may exceed the available memory.

For these and other reasons, therefore, there is a need for the present invention.

### SUMMARY OF THE INVENTION

The present invention relates to generating a database representation of a markup-language document. A method of one embodiment of the invention parses a document formatted in a markup language, such as the eXtensible Markup Language (XML), and that has a number of nodes organized in a tree structure. For each node of the document, at least the following is performed. First, a unique numerical identifier for the node is stored in a row of a first database table that represents a structure of the document. Second, a text value of the node is stored in a row of a second database table by the unique numerical identifier for the node. The second database table stores the text values of the nodes of the document. The document is thus accessible by performing query operations against the first database table and the second database table.

A system of one embodiment of the invention includes a storage and at least an access component. The storage stores a first database table and a second database table. The first database table represents a structure of a document formatted in a markup language and having a number of nodes organized in a tree structure. The first database table has a number of rows, each of which corresponds to a node of the document and storing at least a unique numerical identifier for the node. The second database table stores text values of the nodes of the document. The second database table also has a number of rows, each of which corresponds to a node of the document and stores at least a text value of the node by the unique numerical identifier for the node. The access component receives query operations to access the document against the first and the second database tables.

A computer-readable medium of one embodiment of the invention has a computer program stored thereon to perform a method. The medium may be a tangible computer-readable medium, such as a recordable data storage medium. The method parses a document formatted in a markup language and having a number of nodes organized in a tree structure. For each node of the document, at least the following is performed. First, a unique numerical identifier for the node is stored in a row of a first database table representing a structure of the document. Second and third, a unique numerical identifier of a parent node of this node, and a unique numerical identifier of a last (i.e., most recent) descendant node of this node, are stored in this same row of the first database table. Fourth, a text value of this node is stored in a row of a second database table by the unique numerical identifier for the node. The second database table thus stores the text values of the nodes of the document. The document is accessible by query operations against the first and the second database tables.

Embodiments of the invention provide for advantages over the prior art. Both the data of a markup-language document—i.e., its text values—and the tree structure of the document are stored in database tables. A first database table stores the structure of the document, whereas a second database table stores the data of the document. Neither of these tables is stored in memory. Thus, the document is not completely stored in memory at any time, nor is a map representing the structure of the document completely stored in memory. As such, out-of-memory errors are at least nearly completely avoided, unlike in the lazy-loading, the improved lazy-loading, and other prior art approaches, which only serve to minimize out-of-memory errors occurring.

Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a rudimentary example document formatted in a markup language, in relation to which some embodiments of the invention are described.

FIG. 2 is a diagram of a tree structure of the markup-language document of FIG. 1, in relation to which some embodiments of the invention are described.

FIG. 3A is a diagram of a first database table representing the structure of the markup-language document of FIGS. 1 and 2, according to an embodiment of the invention.

FIG. 3B is a diagram of a second database table storing the text values of the markup-language document of FIGS. 1 and 2, according to an embodiment of the invention.

FIGS. 4A and 4B are diagrams of the first and the second database tables of FIGS. 3A and 3B, according to a more particular embodiment of the invention.

FIG. 5 is a flowchart of a method for generating a database table representation of a markup-language document, according to an embodiment of the invention.

FIG. 6 is a diagram of rudimentary system, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

### Overview and Method

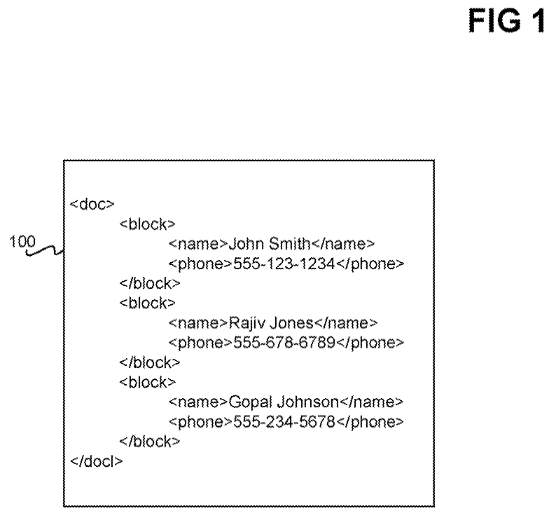

FIG. 1 is a diagram of a rudimentary and simple markup-language document 100, in relation to which some embodiments of the invention are described. The document 100 is specifically formatted in accordance with the eXtensible Markup Language (XML). The tags <doc> and </doc> surround the data that is stored in the document 100. The tags <block> and </block> denote different blocks of data in the document 100. Each block of data includes a name, surrounded by the tags <name> and </name>, and a phone number, surrounded by the tags <phone> and </phone>.

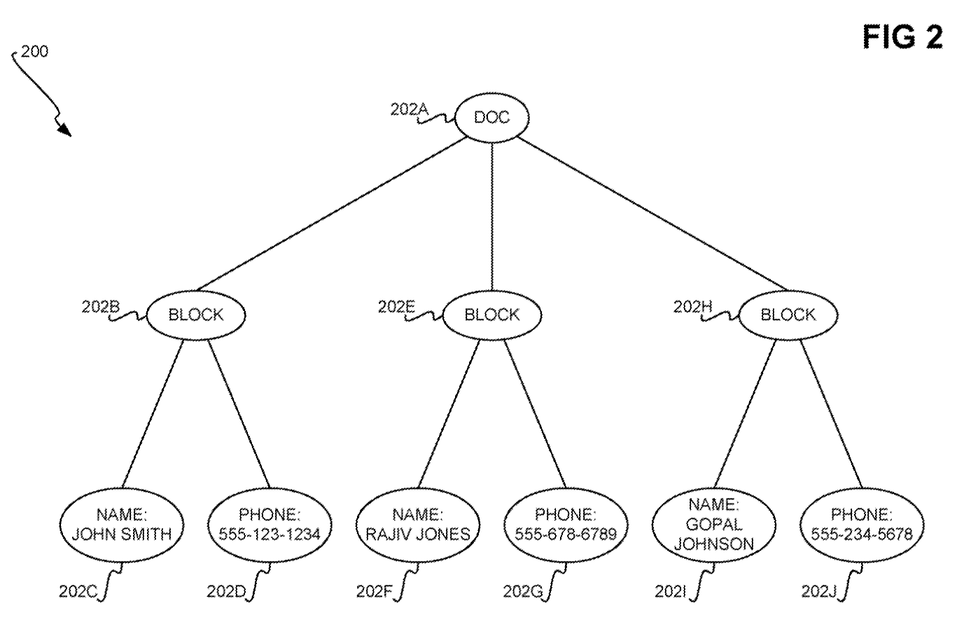

FIG. 2 is a diagram of a tree structure 200 corresponding to the markup-language document 100. The tree structure 200 includes nodes 202A, 202B, 202C, 202D, 202E, 202F, 202G, 202H, 202I, and 202J, collectively referred to as the nodes 202. The node 202A, corresponding to the tag <doc>, is the parent node to nodes 202B, 202E, and 202H, corresponding to the <block> tags. The node 202B is the parent node to nodes 202C and 202D, corresponding to the data “John Smith” preceded by the tag <name> and the data “555-123-1234” preceded by the tag <phone>. The nodes 202C and 202D are descendant nodes of the node 202B.

The node 202E is the parent node to the nodes 202F and 202G, corresponding to the data “Rajiv Jones” preceded by the tag <name> and the data “555-678-6789” preceded by the tag <phone>. The nodes 202F and 202G are descendant nodes of the node 202E. The node 202H is the parent node to the nodes 202I and 202J, corresponding to the data “Gopal Johnson” preceded by the tag <name> and the data “555-234-5678” preceded by the tag <phone>. The nodes 202I and 202J are descendent nodes of the node 202H.

The nodes 202 are implicitly ordered in accordance with their appearance within the markup-language document 100. Thus, the node 202A is first, because the tag <doc> appears first in the document 100. The node 202B is second, because the associated tag <block> appears second in the document 100. Likewise, the nodes 202C and 202D are third and fourth, respectively, because their associated tags <name> and <phone>, with respect to the data “John Smith” and “555-123-1234,” appear or occur third and fourth, respectively, in the document 100. The node 202J is last, because its associate tag <phone>, with respect to the data “555-234- 55678,” appears or occurs last within the document 100.

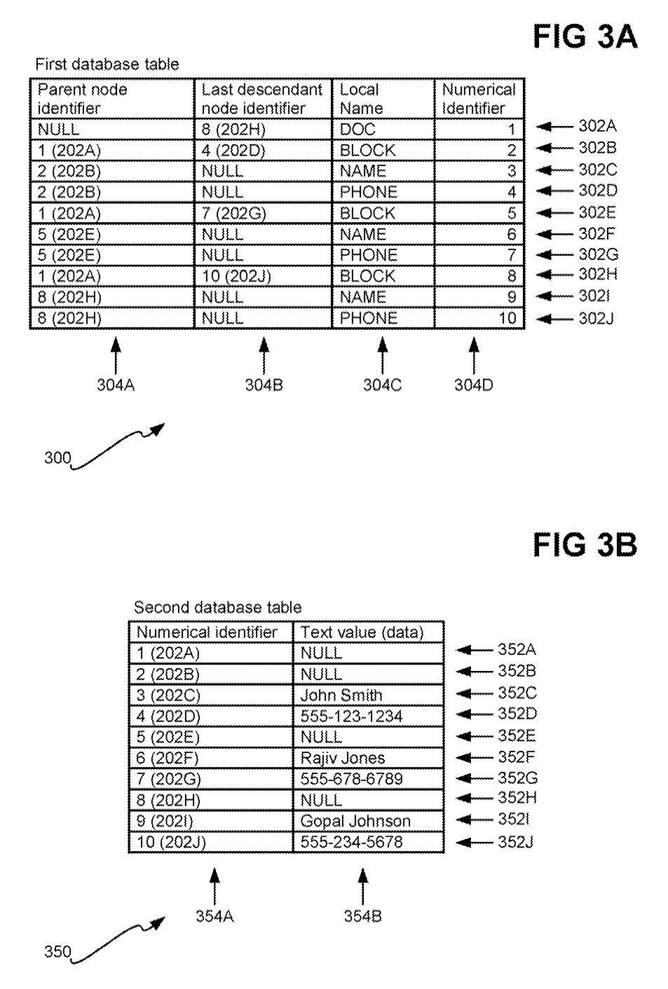

FIGS. 3A and 3B show two database tables 300 and 350, respectively, that are generated from the markup-language document 100 having the tree structure 200, according to an embodiment of the invention. The database tables 300 and 350 may be database tables that are accessible by performing query operations, such as Standard Query Language (SQL) queries, such that the database tables 300 and 350 may themselves be considered SQL database tables. The database tables 300 and 350 are typically not stored in memory, and thus can be employed to access the document 100 without having to load the entire document 100 within memory, as is described in more detail later in the detailed description.

In FIG. 3A, the first database table 300 includes rows 302A, 302B, 302C, 302D, 302E, 302F, 302G, 302H, 302I, and 302J, collectively referred to as the rows 302, and corresponding to the nodes 202 of FIG. 2. The database table 300 includes columns 304A, 304B, 304C, and 304D, collectively referred to as the columns 304. However, there may be more (or less) of the columns 304 than as is depicted in FIG. 3A, which is described in more detail later in the detailed description.

The columns 304 are described in reverse order. The column 304D denotes a unique numerical identifier assigned to a node, where a node having a lesser numerical identifier appears in the markup-language document 100 before a node having a greater numerical identifier. Therefore, the first node 202A has a numerical identifier of one, the second node 202B has a numerical identifier of two, and so on, such that the last node 202J has a numerical identifier of ten.

More generally, the nodes 202 corresponding to the rows 302 are assigned locally or globally unique numerical identifiers such that adjacent nodes within the document 100 are initially separated by a distance value. In the example of FIG. 3A, this distance value is one, such that adjacent nodes have numerical identifiers separated by one. In another embodiment, however, the distance value may be more than one. For example, a distance value of five would mean that the nodes 202 corresponding to the rows 302 are assigned unique numerical identifiers of five, ten, fifteen, twenty, and so on.

The advantage of having a distance value greater than one is that should a node be inserted within the document 100, renumbering of all the numerical identifiers of the nodes 202 corresponding to the rows 302 is less likely to have to occur. That is, two adjacent nodes FIRST and SECOND within the document 100 have to have numerical identifiers such that the node FIRST has a lower numerical identifier than the node SECOND. If two existing adjacent nodes have numerical identifiers separated by five, for instance, then a new node added between these two nodes can be assigned a unique numerical identifier that is between their two numerical identifiers.

By comparison, if two adjacent nodes FIRST and SECOND within the document 100 have numerical identifiers separated by one, for instance, then a new node added between these two nodes cannot be assigned a unique (integer) numerical identifier that is between their two numerical identifiers. As a result, the numerical identifiers of at least a portion of the nodes 202 corresponding to the rows 302 have to be renumbered. Where there are a large number of nodes, this renumbering process can be time-consuming. The distance value may thus be configured by a user, or automatically determined by using a known separation distance algorithm.

In one embodiment, the numerical identifier is unique for each given sub-tree. Furthermore, each row may have an operation identifier that identifies the sub-tree of which it is a part, which is not particularly depicted in FIGS. 3A and 3B. Therefore, the combination of the numerical identifier and the operation identifier in this embodiment is globally unique. For instance, consider the following example markup-language document:

<a>
<b>text1</b>
<c>text2</c>

</a>

The numerical identifiers for a, b, text1, c, and text2 may be 0, 1, 2, 3, and 4, respectively. However, the operation identifier for all of these may be 0. If a new sub-tree starting at c is cloned, then there are two sub-trees, the sub-tree noted above, and the following tree: <c>text2</c>. In this case, the new sub-tree has numerical identifiers of 0 and 1 for c and text2, respectively, but each of these have the same operation identifier of 1.

The column 304C denotes the local name of a node, which can correspond to the name of the tag of the node. Thus, the node 202A corresponding to the row 302A has the local name “doc,” and the node 202B corresponding to the row 302B has the local name “block.” Likewise, the node 202C corresponding to the row 302C has the local name “name,” the node 202D corresponding to the row 302D has the local name “phone,” and so on.

The column 304B denotes the unique numerical identifier of the last descendant of a node. For example, the node 202A corresponding to the row 302A stores the unique numerical identifier eight, since the node 202H is the last descendant of the node 202A. The last descendant of a node is the most direct descendant of the node that appears last within the markup-language document 100. Therefore, for the node 202A, the direct descendants 202B and 202E are each not the last descendant, because both appear within the document 100 before the direct descendant 202H does. Similarly, for the node 202A, the nodes 202I and 202J are each not the last descendant, even though they appear within the document 100 after the direct descendant 202H does, because they are not direct descendants of the node 202A. If a node has no descendants, the row corresponding to the node may have the value “NULL” within the column 304B.

The column 304A denotes the unique numerical identifier of the parent of a node. Where a node does not have a parent node, the row corresponding to the node may have the value “NULL” within the column 304A. For example, the node 202A corresponding to the row 302A has the value “NULL” because the node 202A does not have a parent node. The node 202B corresponding to the row 302B has the value one, which is the numerical identifier of the node 202A that is the parent of the node 202B. Similarly, the node 202C corresponding to the row 302C has the value two, which is the numerical identifier of the node 202B that is the parent of the node 202C.

In FIG. 3B, the second database table 350 includes rows 352A, 352B, 352C, 352D, 352E, 352F, 352H, 352I, and 352J, collectively referred to as the rows 352, and corresponding to the nodes 202 of FIG. 2. The database table 350 includes columns 354A and 354B, collectively referred to as the columns 354. However, there may be more of the columns 354 than as is depicted in FIG. 3B, which is described in more detail later in the detailed description.

The column 354A denotes the numerical identifier of the node to which a given row corresponds. For example, the row 352A stores the numerical identifier one, since it corresponds to the node 202A. The row 352B stores the numerical identifier two, since it corresponds to the node 202B, the row 352C stores the numerical identifier three, since it corresponds to the node 202C, and so on. The numerical identifier for a given node is determined by looking up the node in question within the first database table 300.

The columns 354B stores the data, or text value, of the node to which a given row corresponds. Where a node does not store any data, the column 354B may store the value “NULL.” For example, the nodes 202A and 202B, corresponding to the rows 352A and 352B have no data or text values, such that the column 354B is depicted as including the value “NULL” in these rows. By comparison, the nodes 202C and 202D, corresponding to the rows 352C and 352D have the data or text values “John Smith” and “555-123-1234,” respectively, such that the column 354B is depicted as including these values in these rows.

In general, then, the first database table 300 stores or represents the tree structure 200 of the markup-language document 100, whereas the second database table 350 stores the data or text values of the markup-language document 100. Once the database tables 300 and 350 have been constructed or generated, the markup-language document 100 can be accessed without having to load the document 100 into memory. Rather, standard database query operations, such as SQL queries, can be formulated to determine the structure of the document 100, via the database 300, as well as the data stored in the document 100, via the database table 350. Out-of-memory errors are thus substantially avoided.

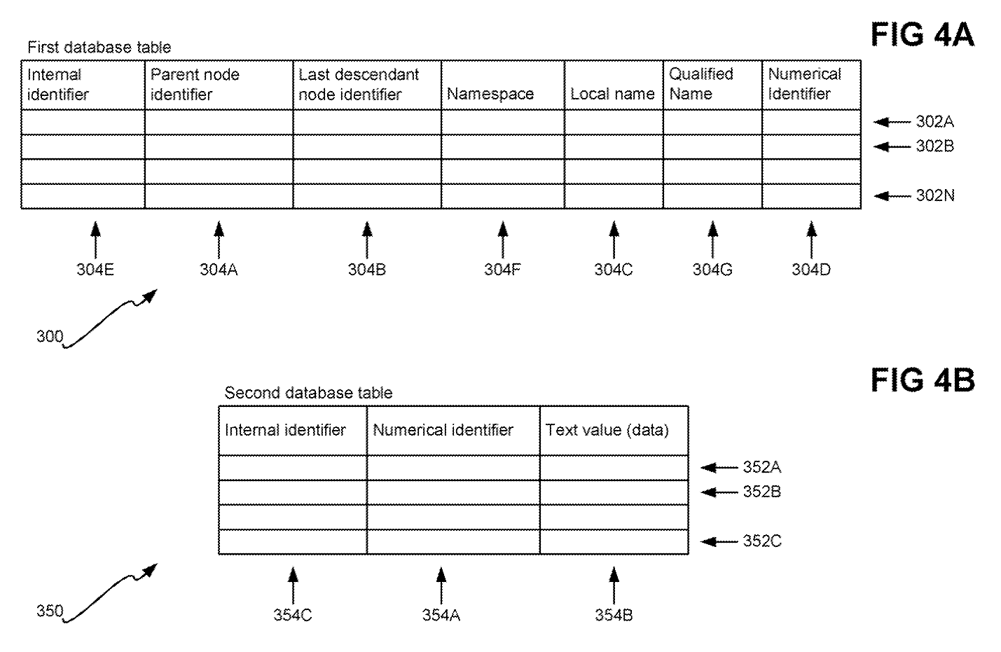

FIGS. 4A and 4B show the two database tables 300 and 350, respectively, according to a more particular embodiment of the invention. The database table 300 of FIG. 3A is depicted as generally having rows 302A, 302B, . . . , 302N, collectively referred to as the rows 302, and which are not populated with values for descriptive and illustrative convenience and clarity. Likewise, the database 350 of FIG. 3B is depicted as generally having rows 352A, 352B, . . . , 352N, collectively referred to as the rows 352, and which are also not populated with values for descriptive and illustrative convenience and clarity.

In FIG. 4A, the first database table 300 includes the columns 304E, 304F, and 304G, in addition to the columns 304A, 304B, 304C, and 304D that have been described in relation to FIG. 3A. The column 304E denotes an internal identifier of a row. The internal identifier may be generated by the database itself so that the database is able to discern one row from another. It is thus a technical implementation detail.

The column 304F denotes the namespace of a node within the markup-language document corresponding to a row in question. As can be appreciated by those of ordinary skill within the art, the namespace is a collection of names, identified by a universal resource identifier (URI) reference. It is further noted that XML namespaces in particular differ from the namespaces conventionally used in computing disciplines in that the XML version has internal structure and is not, mathematically speaking, a set.

The column 304G denotes the qualified name of a node within the markup-language document corresponding to a row in question. The qualified name of a node is more specific than the local name denoted by the column 304C that has been described. Technically, in XML documents in particular, a qualified name is defined as having a prefix and a local part, as can be appreciated by those of ordinary skill within the art. The prefix corresponds to a namespace prefix, is associated with the namespace identified in the column 304F for a particular node corresponding to a particular row, and may be considered a placeholder for this namespace. The local part is the name of the node within the namespace. That is, the node may have a local name as denoted by the column 304C, but may have a qualified name as is actually used within the namespace identified by the column 304F.

In FIG. 4B, the second database table 350 includes the column 354C in addition to the columns 354A and 354B that have been described in relation to FIG. 3B. As with the column 304E of the first database table 300 of FIG. 4A, the column 354C denotes an internal identifier of a row. The internal identifier may be generated by the database itself so that the database is able to discern one row from another. It is thus a technical implementation detail.

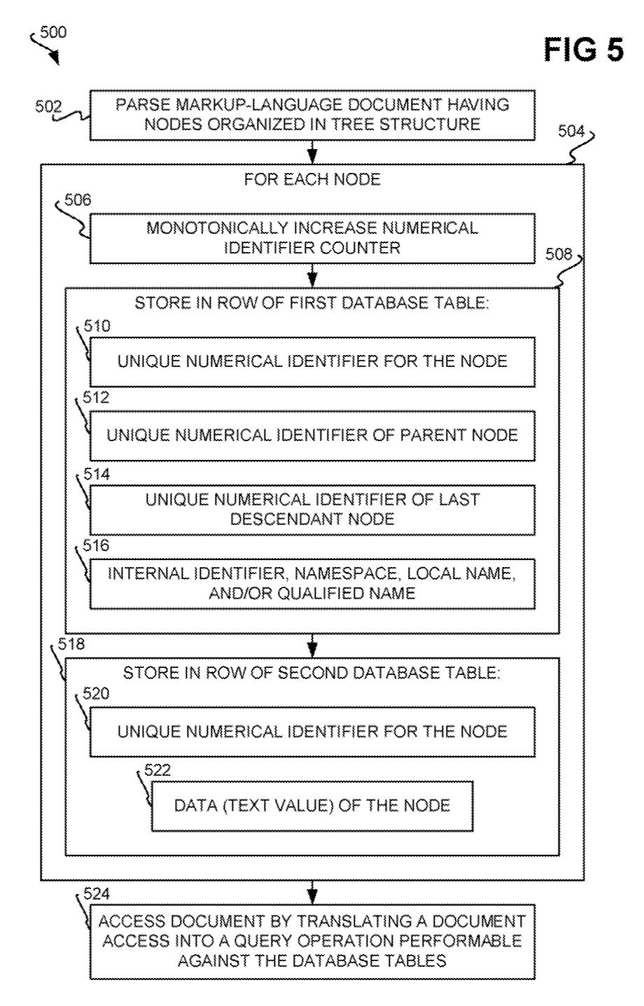

FIG. 5 shows a method 500, according to an embodiment of the invention. The method 500 may be implemented as one or more computer programs stored on a computer-readable medium. The medium may a tangible computer-readable medium, such as a recordable data storage medium.

A markup-language document that has nodes organized in a tree structure is parsed (502). For instance, parsing may be achieved by translating the document using a Simple Application Programming Interface (API) for XML (SAX) events, in one embodiment of the invention. SAX is an event-driven model for processing and representing XML data, and is described in detail at the Internet web site http://www.saxproject.org/.

For each node of the document encountered, the following is performed (504). First, a numerical identifier counter is monotonically increased by a distance value (506). For instance, where the value of the numerical identifier counter is initially zero, then it may be incremented to the distance value itself. After processing of part 504 for the first node, the numerical identifier counter is thus equal to the numerical identifier of the first node, such that it is incremented by the distance value to arrive at a new counter value to set as the numerical identifier for the second node.

As has been described, in one embodiment, the distance value may be one, such that insertion of additional nodes into the document results in renumbering of the unique numerical identifiers of the existing nodes of the document to accommodate the additional nodes. The distance value may also be configurable, either by a user or by performing an appropriate algorithm, when the method 500 is performed. For instance, the distance value may be set sufficiently high, as has been described, so that subsequent insertion of additional nodes into the document does not necessarily result in renumbering of the unique numerical identifiers of the existing nodes to accommodate the additional nodes.

A new row for the node being processed is created within the first database table, and the following information is desirably stored in that new row (508): a unique numerical identifier for the node (510), the unique numerical identifier of the parent node (512), and the unique numerical identifier of the last descendant node (514). Other information that may be stored in the row includes the internal identifier, namespace, the local name, and/or the qualified name of the node (516), as has been described. It is noted that the unique numerical identifier of the last descendant node may not be initially known when a node is encountered in the document. Therefore, this identifier may be updated as the document continues to be processed.

For example, consider the markup-language document 100 of FIG. 1, having the tree structure 200 of FIG. 2. The last descendant node for the node 202A is the node 202H, as has been described. However, when the node 202A is initially processed, this information is not known. Furthermore, the node 202B is processed before the node 202E, and it is not known that the node 202E exists when the node 202B is processed. Similarly, the node 202E is processed before the node 202H, and it is not known that the node 202H exists when the node 202E is processed. Therefore, as each of the direct descendant nodes 202B, 202E, and 202H are processed, its unique numerical identifier is added to the row for the node 202A as the last descendant node of the node 202A.

For example, when the node 202B is processed, it is known that the parent node of the node 202B is the node 202A. Therefore, the unique identifier for the node 202B is added to the row corresponding to the node 202A, as the last descendant node to the node 202A. However, when the node 202E is processed, it is known that the parent node of the node 202E is also the node 202A, such that the node 202E is a more recent descendant node to the node 202A. Therefore, the unique identifier for the node 202E is substituted within the row corresponding to the node 202A, as the last descendant node to the node 202A.

Finally, when the node 202H is processed, it is known that the parent node of the node 202H is also the node 202A, such that the node 202H is a more recent descendant node to the node 202A. Therefore, the unique identifier for the node 202H is substituted within the row corresponding to the node 202A, as the last descendant node to the node 202A. Processing the last descendant nodes in this manner ensures that once the markup-language document 100 has been completely processed, the unique identifiers of the last descendant nodes are correct.

Referring back to FIG. 5, a new row for the node being processed is also created within the second database table, and the following information is desirably stored in that new row (518): the unique numerical identifier for the node (520), and the data, or text value, of the node (522), as has been described. Once all of the nodes of the document have been processed in this manner, by performing part 504 of the method 500, the two database tables represent both the structure of the markup-language document, in the first database table, and the data of the document, in the second database table. Therefore, the markup-language document is accessed by translating such document accesses into query operations, such as SQL queries, performable against the database tables (524).

### System and Conclusion

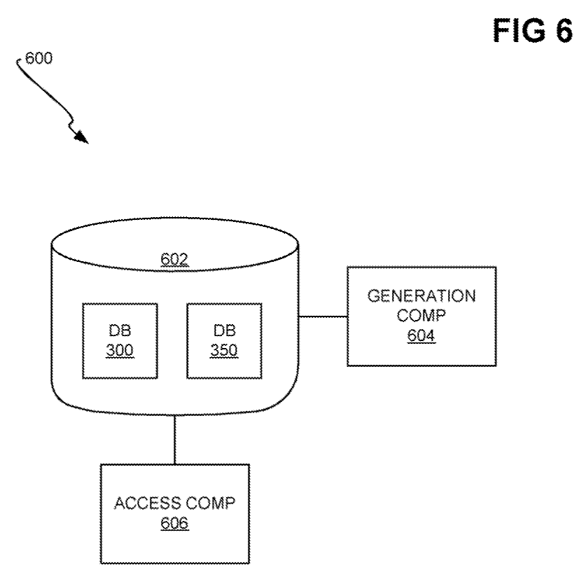

FIG. 6 shows a computerized system 600, according to an embodiment of the invention. The system 600 includes a storage 602, a generation component 604, and an access component 606. As can be appreciated by those of ordinary skill within the art, the system 600 may include other components or parts, in addition to and/or in lieu of those depicted in FIG. 6.

The storage 602 is a hard disk drive, or another type of storage device. However, in at least some embodiments, the storage 602 is not and/or does not include volatile memory, such as dynamic random-access memory (DRAM). The storage 602 stores the database tables 300 and 350 that have been described.

The generation component 605 and the access component 606 may each be implemented in hardware, software, or a combination of hardware and software. The generation component 604 generates the database tables 300 and 350 by parsing a markup-language document, and without ever completely storing the document in memory, such as DRAM. The access component 606 receives query operations to access the markup-language document by processing the query operations against the database tables 300 and 350, as has been described.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A method comprising:
parsing a document formatted in markup language and having a plurality of nodes organized in a tree structure;
for each node of the document,
storing a unique numerical identifier for the node in a row of a first database table representing a structure of the document; and,
storing a text value of the node in a row of a second database table by the unique numerical identifier for the node, the second database table storing the text values of the nodes of the document,
wherein the document is accessible by query operations against the first database table and the second database table.

2. The method of claim 1, wherein the document is not completely stored in memory at any time.

3. The method of claim 1, wherein a map representing the structure of the document is not stored in memory.

4. The method of claim 1, wherein parsing the document comprise SAX processing the document.

5. The method of claim 1, further comprising, for each node of the document,
storing in the row of the first database table, along with the unique numerical identifier,
a unique numerical identifier of a parent node of the node; and
a unique numerical identifier of a last descendant node of the node.

6. The method of claim 1, further comprising, for each node of the document,
storing in the row of the first database table, along with the unique numerical identifier, one or more of:
a namespace of the node;
a local name of the node; and,
a qualified name of the node.

7. The method of claim 1, further comprising, for each node of the document,
storing in the row of the second database table, along with the text value of the node, the unique numerical identifier of the node.

8. The method of claim 1, further comprising accessing the document by translating a document access into a query operation performable against one or more of the first database table and the second database table.

9. The method of claim 1, wherein storing the unique numerical identifier for the node comprises monotonically increasing a unique numerical identifier of a previous node processed by a distance value.

10. The method of claim 9, wherein the distance value is one, such that insertion of one or more additional nodes into the document results in renumbering of the unique numerical identifiers of the nodes of the document to accommodate the additional nodes.

11. The method of claim 9, wherein the distance value is configurable when the method is performed.

12. The method of claim 9, wherein the distance value is set sufficiently high so that subsequent insertion of one or more additional nodes into the document does not result in renumbering of the unique numerical identifiers of the nodes of the document to accommodate the additional nodes.

13. The method of claim 1, wherein the markup language is eXtensible Markup Language (XML).

14. The method of claim 1, wherein the first and the second database tables are each a Structured Query Language (SQL) database table, and the query operations are SQL query operations.

15. A system comprising:
a storage to store:
a first database table representing a structure of a document formatted in a markup language and having a plurality of nodes organized in a tree structure, the first database table having a plurality of rows, each row corresponding to a node of the document and
storing at least a unique numerical identifier for the node; and,
a second database table storing text values of the nodes of the document, the second database table having a plurality of rows, each row corresponding to a node of the document and storing at least a text value of the node by the unique numerical identifier for the node; and,
an access component to receive query operations to access the document against the first database table and the second database table.

16. The system of claim 15, further comprising a generation component to generate the first database table and the second database table by parsing the document and without completely storing the document in memory.

17. The system of claim 15, wherein each row of the first database table further stores, for the node of the document to which the row corresponds:
a unique numerical identifier of a parent node of the node; and,
a unique numerical identifier of a last descendant node of the node.

18. The system of claim 15, wherein each row of the first database table further stores, for the node of the document to which the row corresponds, one or more of :
a namespace of the node;
a local name of the node; and,
a qualified name of the node.

19. The system of claim 15, wherein adjacent numerical identifiers of the nodes are separate by a distance value equal to one of:
a value of one; and,
a value sufficiently high so that subsequent insertion of one or more additional nodes into the document does not result in renumbering of the unique numerical identifiers of the nodes of the document to accommodate the additional nodes.

20. A computer-readable medium having a computer program stored thereon to perform a method comprising:
parsing a document formatted in a markup language and having a plurality of nodes organized in a tree structure;
for each node of the document,
storing a unique numerical identifier for the node in a row of a first database table representing a structure of the document;
storing a unique numerical identifier of a parent node of the node in the row of the first database table;
storing a unique numerical identifier of a last descendant node of the node in the row of the first database table; and,
storing a text value of the node in a row of a second database table by the unique numerical identifier for the node, the second database table storing the text values of the nodes of the document,
wherein the document is accessible by query operation against the first database table and the second database table.
